(19) United States
(12) Patent Application Publication
(10) Pub. No.: US 2017/0185018 A1
(43) Pub. Date: Jun. 29, 2017

(54) FIXING DEVICE AND IMAGE FORMING APPARATUS

(71) Applicant: FUJI XEROX CO., LTD., Tokyo (JP)

(72) Inventors: Yuki YOKOYAMA, Kanagawa (JP); Mitsuhiro MATSUMOTO, Kanagawa (JP); Keitaro MORI, Kanagawa (JP)

(73) Assignee: FUJI XEROX CO., LTD., Tokyo (JP)

(21) Appl. No.: 15/152,677

(22) Filed: May 12, 2016

(30) Foreign Application Priority Data
Dec. 25, 2015 (JP) 2015-252773

(51) Int. Cl. G03G 15/20

(52) U.S. Cl. CPC G03G 15/2053

(57) ABSTRACT

A fixing device includes a fixing unit that includes a first heating unit and a pressing unit that forms a fixing region, in which a recording material is sandwiched between the pressing unit and the first heating unit and an image on the recording material is fixed onto the recording material, a second heating unit that applies heat to a portion of the recording material, the portion not having reached the fixing region, and a deformation-suppression unit that suppresses deformation of the recording material due to the heat applied to the recording material by the second heating unit.

### CROSS-REFERENCE TO RELATED APPLICATIONS

This application is based on and claims priority under 35 USC 119 from Japanese Patent Application No. 2015-252773 filed Dec. 25, 2015.

### BACKGROUND

Technical Field

The present invention relates to a fixing device and an image forming apparatus.

### SUMMARY

According to an aspect of the invention, there is provided a fixing device including a fixing unit that includes a first heating unit and a pressing unit that forms a fixing region, in which a recording material is sandwiched between the pressing unit and the first heating unit and an image on the recording material is thereby fixed onto the recording material, a second heating unit that applies heat to a portion of the recording material, the portion not having reached the fixing region, and a deformation-suppression unit that suppresses deformation of the recording material due to the heat applied to the recording material by the second heating unit.

### BRIEF DESCRIPTION OF THE DRAWINGS

An exemplary embodiment of the present invention will be described in detail based on the following figures, wherein:

FIG. 1 is a diagram illustrating an exemplary configuration of an image forming apparatus;

FIG. 2 is a cross-sectional view illustrating a configuration of a fixing device; and

FIGS. 3A and 3B are diagrams respectively illustrating a toner image that is not heated by a heating unit and a toner image that is heated by the heating unit.

### DETAILED DESCRIPTION

An exemplary embodiment of the present invention will be described in detail below with reference to the accompanying drawings.

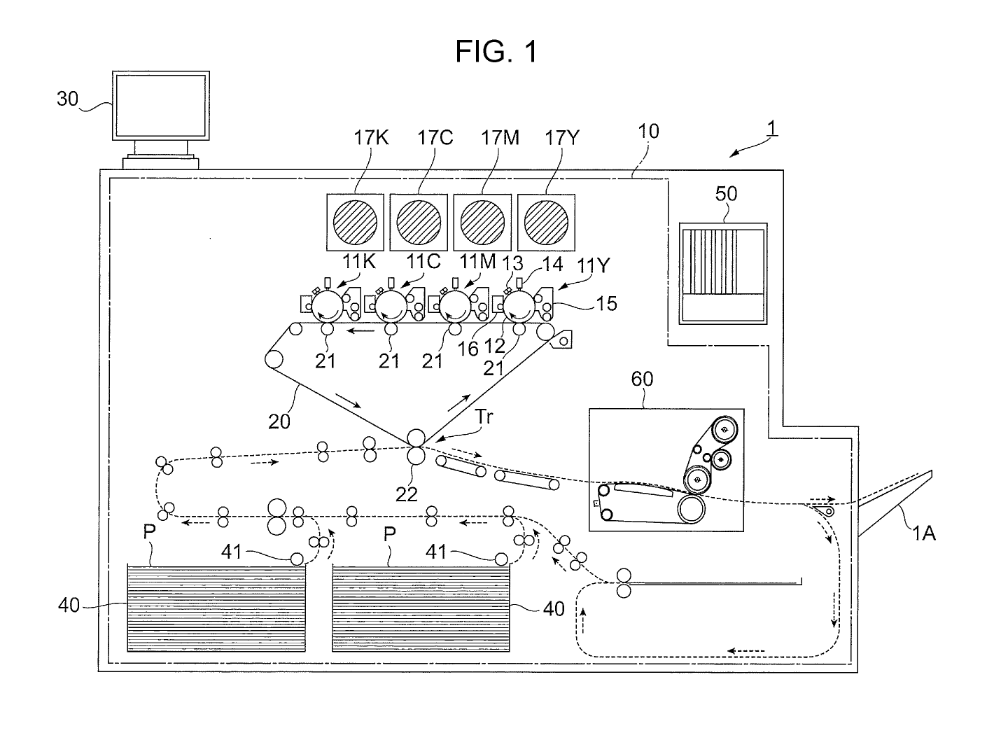

FIG. 1 is a diagram illustrating an exemplary configuration of an image forming apparatus 1 according to the present exemplary embodiment.

The image forming apparatus 1 illustrated in FIG. 1 is a so-called tandem-type color printer and includes an image forming unit 10 that performs image formation on the basis of image data. In addition, the image forming apparatus 1 is provided with a controller 50.

The controller 50 includes a program-controlled central processing unit (CPU) and controls the operations of each device and each functional unit that are included in the image forming apparatus 1. The controller 50 performs communication with a personal computer and the like, performs processing on image data, and the like.

In addition, the image forming apparatus 1 is provided with a user interface unit 30, which receives an operation input from a user and performs display of various information items to a user.

The image forming unit 10, which is an example of an image forming unit, is a functional unit that employs, for example, an electrophotographic system and forms an image. The image forming unit 10 includes four image forming units, which are an image forming unit 11Y that corresponds to yellow (Y), an image forming unit 11M that corresponds to magenta (M), an image forming unit 11C that corresponds to cyan (C), and an image forming unit 11K that corresponds to black (K).

Note that, in the following description, when there is no need to distinguish particular image forming units from each other, the image forming units will be referred to as image forming units 11.

The image forming units 11, which are the image forming unit 11Y, the image forming unit 11M, the image forming unit 11C, and the image forming unit 11K, respectively form toner images of yellow, magenta, cyan, and black.

Each of the image forming units 11 includes a photoconductor drum 12 on which a toner image of the corresponding color is to be formed after an electrostatic latent image has been formed on the photoconductor drum 12.

In addition, each of the image forming units 11 includes a charger 13 that charges a surface of the corresponding photoconductor drum 12 and an exposure unit 14 that exposes the photoconductor drum 12, which has been charged by the charger 13, to light on the basis of image data.

Furthermore, each of the image forming units 11 includes a developing unit 15 that develops, with the corresponding color toner, an electrostatic latent image formed on the corresponding photoconductor drum 12 and a cleaner 16 that cleans the surface of the photoconductor drum 12 after a toner image of the corresponding color has been transferred.

Note that the configurations of the image forming units 11 are similar to one another except with regard to the toners contained in the developing units 15.

The image forming unit 10 includes an intermediate transfer belt 20 onto which toner images of the different colors, which have been formed on the photoconductor drums 12 of the image forming units 11, are transferred and first transfer rollers 21 that transfer (in a first transfer process) the toner images of the different colors formed by the image forming units 11 onto the intermediate transfer belt 20.

In addition, the image forming unit 10 includes a second transfer roller 22 that collectively transfers (in a second transfer process) the toner images of the different colors, which have been transferred to the intermediate transfer belt 20 in such a manner as to be superposed with one another, onto one of recording materials P.

Furthermore, the image forming unit 10 includes a fixing device 60 that fixes the toner images of the different colors, which have been transferred in the second transfer process to the recording material P, onto the recording material P.

Here, examples of the recording materials P include sheets, resin sheets, and resin films.

Note that, in the present exemplary embodiment, a region in which the second transfer roller 22 is disposed and in which toner images of the different colors on the intermediate transfer belt 20 are transferred in the second transfer process onto one of the recording materials P will hereinafter be referred to as a second transfer region Tr.

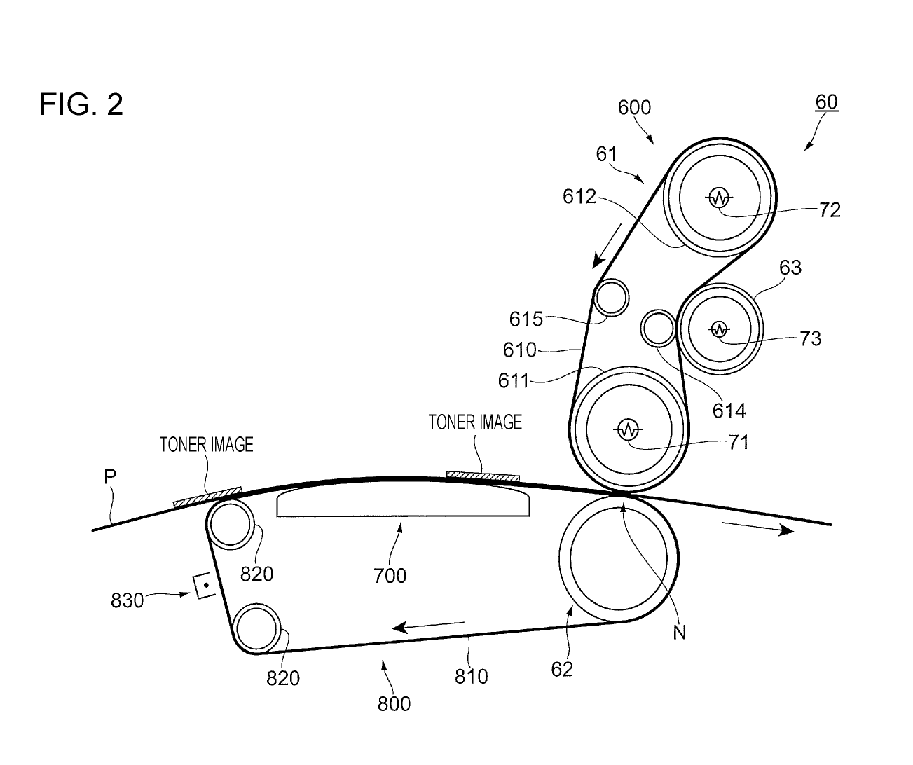

FIG. 2 is a cross-sectional view illustrating the configuration of the fixing device 60.

As illustrated in FIG. 2, the fixing device 60 includes a fixing unit 600. The fixing unit 600, which is an example of a fixing unit, applies heat and pressure to one of the recording materials P and fixes toner images, which have been transferred to the recording material P, onto the recording material P.

In addition, a heating unit 700 is disposed at a position upstream from the fixing unit 600 in a transport direction of the recording materials P. The heating unit 700, which is an example of a second heating unit, applies heat to one of the recording materials P, which is fed to the fixing unit 600, at a position upstream from the fixing unit 600. In other words, the heating unit 700 applies heat to a portion of the recording material P, the portion not having reached a nip part N (fixing region).

In order to heat one of the recording materials P by using only the fixing unit 600, the output of the fixing unit 600 needs to be increased, and accordingly, the size of the fixing unit 600 is likely to increase.

In addition, in the present exemplary embodiment, a deformation-suppression mechanism 800 is disposed at a position upstream from the fixing unit 600 in the transport direction of the recording materials P.

The deformation-suppression mechanism 800, which is an example of a deformation-suppression unit, suppresses deformation of one of the recording materials P due to heat applied to the recording material P by the heating unit 700.

The fixing unit 600 includes a fixing belt module 61, which includes a fixing belt 610, and a pressure roller 62 that is pressed against the fixing belt module 61. In addition, the fixing unit 600 includes an external heating roller 63 that heats the fixing belt 610 while stretching the fixing belt 610 from the outside.

In the present exemplary embodiment, one of the recording materials P on which toner images have been placed is sandwiched between the fixing belt 610, which is an example of a first heating unit, and the pressure roller 62, which is an example of a pressing unit, and heat and pressure are applied to the recording material P such that the toner images are fixed onto the recording material P.

As an additional point, in the present exemplary embodiment, the fixing region (nip part N) in which toner images on one of the recording materials P are fixed onto the recording material P is formed between the fixing belt 610 and the pressure roller 62 as a result of the pressure roller 62 being pressed against the fixing belt 610. In the present exemplary embodiment, when one of the recording materials P is fed to the fixing region, the recording material P is sandwiched between the fixing belt 610 and the pressure roller 62, and heat and pressure are applied to the recording material P. As a result, toner images on the recording material P are fixed onto the recording material P.

The fixing belt module 61 includes the fixing belt 610 that moves circularly and a fixing roller 611 that heats the fixing belt 610 from a space enclosed by the fixing belt 610.

The fixing roller 611 rotates in a counterclockwise direction in FIG. 2 while stretching the fixing belt 610. In addition, the fixing roller 611 is pressed against the pressure roller 62 in the nip part N, which is a region in which the fixing belt module 61 and the pressure roller 62 are pressed into contact with each other (are in contact with each other while being pressed against each other).

In addition, the fixing belt module 61 includes an internal heating roller 612 that heats the fixing belt 610. A counter roller 614 is disposed at a position downstream from the nip part N in such a manner as to face the external heating roller 63 with the fixing belt 610 interposed between the counter roller 614 and the external heating roller 63.

A stretching roller 615 that stretches the fixing belt 610 from the space enclosed by the fixing belt 610 is disposed at a position downstream from the internal heating roller 612 and upstream from the nip part N.

The fixing belt 610 includes a base layer, an elastic body layer, which is stacked on a surface (outer peripheral surface) of the base layer, and a release layer, which covers a surface of the elastic body layer.

The fixing belt 610 has an endless shape (annular shape).

The fixing roller 611 is a cylindrical roller. The fixing roller 611 rotates in the counterclockwise direction in FIG. 2 as a result of receiving a rotational driving force from a drive motor (not illustrated). The fixing roller 611 is heated to a predetermined temperature by a halogen heater 71 that is disposed in an area inside the fixing roller 611.

The internal heating roller 612 is a cylindrical roller. The internal heating roller 612 is heated to a predetermined temperature by a halogen heater 72 that is disposed in an area inside the internal heating roller 612.

The external heating roller 63 is a cylindrical roller. The external heating roller 63 is heated to a predetermined temperature by a halogen heater 73 that is disposed in an area inside the external heating roller 63.

The fixing unit 600 according to the present exemplary embodiment employs a configuration in which the fixing belt 610 is heated by the fixing roller 611, the internal heating roller 612, and the external heating roller 63.

The pressure roller 62 is formed by stacking an elastic body layer on a columnar roller, which serves as a base member, and stacking a release layer on the elastic body layer.

The pressure roller 62 is driven by the fixing roller 611 and rotates in a clockwise direction in FIG. 2 along with rotation of the fixing roller 611 of the fixing belt module 61 in the counterclockwise direction.

The pressure roller 62 is pressed against the outer peripheral surface of the fixing belt 610 with a transport belt 810, which will be described later, interposed therebetween and applies pressure to one of the recording materials P that is positioned between the fixing belt 610 and the pressure roller 62.

As an additional point, in the present exemplary embodiment, pressure and heat are applied to one of the recording materials P on which toner images have been placed as a result of the recording material P being sandwiched between the fixing belt 610 and the pressure roller 62, and the toner images on the recording material P are fixed onto the recording material P.

The heating unit 700 includes a heating source (not illustrated) such as a halogen heater and applies heat to one of the recording materials P that passes above the heating unit 700 in FIG. 2.

In addition, the heating unit 700 applies heat to the recording material P from the side on which a surface of the recording material P is present, the surface of the recording material P being opposite to a surface of the recording material P on which toner images have been formed.

In the present exemplary embodiment, a member that is to be pressed against one of the recording materials P is not provided at a position facing the heating unit 700 (above the heating unit 700 in FIG. 2), and in the present exemplary embodiment, one of the recording materials P is heated by the heating unit 700 in a state where the recording material P is not sandwiched between such a member and the heating unit 700.

In other words, in the present exemplary embodiment, one of the recording materials P is heated by the heating unit 700 in a state where pressure is not applied to the recording material P.

The deformation-suppression mechanism 800 includes the transport belt 810, which is an example of a transport member that transports one of the recording materials P toward the fixing unit 600.

The transport belt 810 has an endless shape (annular shape) and moves circularly in the clockwise direction in FIG. 2.

In the present exemplary embodiment, the heating unit 700 is disposed in a space enclosed by the transport belt 810, which has an annular shape. In addition, the pressure roller 62 is disposed in the space enclosed by the transport belt 810.

In the present exemplary embodiment, the transport belt 810 is configured to pass through the nip part N. This causes one of the recording materials P to reach the fixing unit 600 in a state where deformation of the recording material P is suppressed by the transport belt 810 (details of this matter will be described later).

Plural support rollers 820 are disposed in the space enclosed by the transport belt 810 and support the transport belt 810 from the space enclosed by the transport belt 810. Note that the transport belt 810 rotates as a result of receiving a driving force from the fixing belt 610 that is driven so as to rotate.

The deformation-suppression mechanism 800 further includes a charging device 830 that is formed of a corotron and the like, and in the present exemplary embodiment, the transport belt 810 is charged by the charging device 830.

After one of the recording materials P, which has been transported from the upstream side, has reached the transport belt 810, the recording material P is brought into close contact with a surface of the transport belt 810 by static electricity.

More specifically, in the present exemplary embodiment, one of the recording materials P is heated by the heating unit 700, and in the case where the recording material P is a resin sheet or a resin film, elongation or contraction of the recording material P occurs due to the heat applied by the heating unit 700.

Note that, in the present exemplary embodiment, although one of the recording materials P is brought into close contact with the transport belt 810 by charging the transport belt 810, the recording material P may be brought into close contact with the transport belt 810 by charging the recording material P.

In addition, one of the recording materials P may be brought into close contact with the transport belt 810 by a force other than an electrostatic force.

For example, the transport belt 810 may be made of rubber so that one of the recording materials P and the transport belt 810 will not likely slide over the other, and as a result, the occurrence of contraction and elongation of the recording material P may be suppressed.

More specifically, for example, a fluorocarbon rubber may be provided on the surface of the transport belt 810 so that one of the recording materials P and the transport belt 810 will not likely slide over the other, and as a result, the occurrence of contraction and elongation of the recording material P may be suppressed.

In the present exemplary embodiment, the transport belt 810 is positioned between the heating unit 700 and one of the recording materials P that is heated by the heating unit 700, and the recording material P is heated by the heating unit 700 via the transport belt 810.

Here, in the case of a configuration in which the transport belt 810 is not provided and where one the recording materials P is brought into contact directly with the heating unit 700, the recording material P and the heating unit 700 rub against each other. In this case, if the recording material P is a sheet, paper dust is likely to be generated.

Note that, in the present exemplary embodiment, there is a concern that a powder may be generated due to wearing away of the transport belt 810 as a result of the transport belt 810 and the heating unit 700 being brought into contact with each other. However, in the present exemplary embodiment, an oil is applied to an inner surface of the transport belt 810, so that such a powder due to wearing away of the transport belt 810 is less likely to be generated.

Operation of the image forming apparatus 1 will now be described.

When an image forming operation is performed, the image forming units 11 (see FIG. 1) respectively form toner images of black, cyan, magenta, and yellow through an electrophotographic process.

The toner images of the different colors, which have been formed by the corresponding image forming units 11, are sequentially transferred in a first transfer process onto the intermediate transfer belt 20 by the corresponding first transfer rollers 21 (see FIG. 1), and a superposed toner image, which is formed of the toner images of the different colors superposed with one another, is formed on the intermediate transfer belt 20.

The toner images on the intermediate transfer belt 20 are transported to the second transfer region Tr, in which the second transfer roller 22 is disposed, along with movement of the intermediate transfer belt 20.

In a recording-material transport system, one of the recording materials P that is sent from one of recording-material containers 40 by a corresponding one of feed rollers 41 is transported to the second transfer region Tr along a transport path. In the second transfer region Tr, toner images on the intermediate transfer belt 20 are collectively transferred in the second transfer process onto the recording material P by a transfer electric field formed by the second transfer roller 22.

After that, the recording material P to which the toner images have been transferred is separated from the intermediate transfer belt 20 and is transported to the fixing device 60 along the transport path. The toner images on the recording material P, which has been transported to the fixing device 60, are fixed onto the recording material P by the fixing device 60.

In the fixing device 60 (see FIG. 2), first, one of the recording materials P is placed on the transport belt 810.

In this case, the recording material P is brought into close contact with the surface of the transport belt 810. Then, the recording material P is heated by the heating unit 700. As a result, in the present exemplary embodiment, air and moisture contained in the toners of toner images are discharged to the outside of the toner images.

Here, when the recording material P is heated by the heating unit 700, there is a possibility that elongation or contraction of the recording material P may occur. However, in the present exemplary embodiment, the recording material P is brought into close contact with the transport belt 810, and thus, elongation and contraction of the recording material P are suppressed.

After that, in the present exemplary embodiment, in a state where the recording material P is in close contact with the transport belt 810, the recording material P reaches the nip part N of the fixing unit 600. Subsequently, heat and pressure are applied to the recording material P, and the toner images are fixed onto the recording material P. Then, the recording material P is transported to a recording-material ejection unit 1A (see FIG. 1).

Here, in the configuration of the present exemplary embodiment, one of the recording materials P is heated by the heating unit 700 at a position further upstream than the fixing unit 600.

Here, for example, if the recording material P is a resin film, there is a possibility that steam generated by moisture contained in the toners of the toner images and air that has been expanded in the toners of the toner images may be jetted out from the inside of the toners of the toner images to the outside of the toner image immediately after the recording material P has passed through the nip part N.

More specifically, as a result of applying heat to the toner images in the nip part N, steam is generated in the toners of the toner images, and air is expanded in the toners of the toner images. In this case, the air is not able to escape from the nip part N and collects at, for example, a trailing ends (trailing ends in the transport direction of the recording material P) of the toner images.

Then, after the toner images have been moved outside the nip part N, pressure exerted on the toner images is suddenly decreased, and along with this, the steam and the air that have collected at the trailing ends of the toner images are jetted out of the toner images. In this case, there is a possibility that image irregularities will occur in the toner images.

In contrast, in the present exemplary embodiment, one of the recording materials P is heated (preheated) by the heating unit 700, which is positioned further upstream than the nip part N, as described above. Consequently, before the recording material P reaches the nip part N, at least part of moisture and air contained in a toner image is discharged.

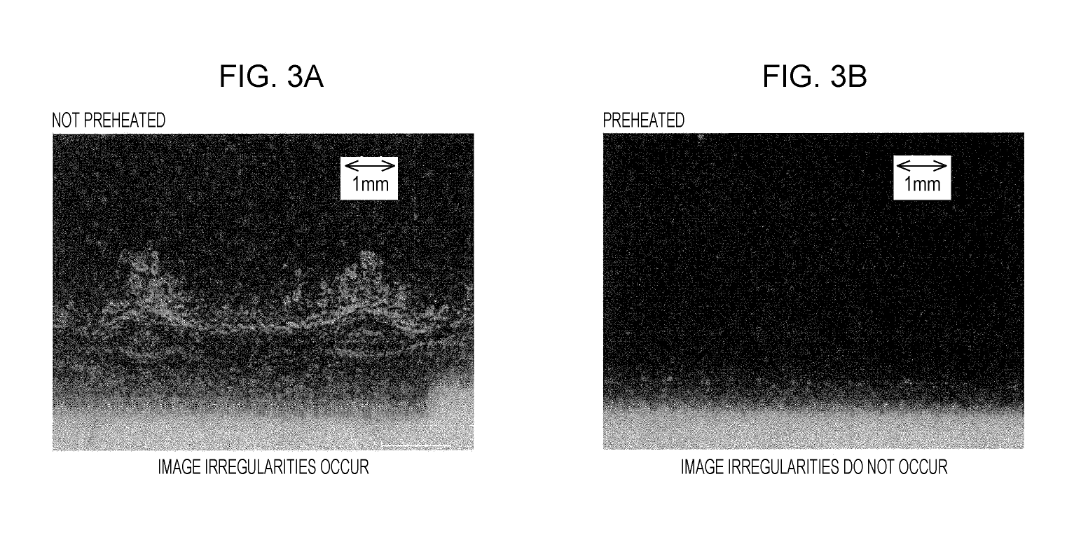

FIGS. 3A and 3B are diagrams respectively illustrating a toner image that is not heated by the heating unit 700 and a toner image that is heated by the heating unit 700. More specifically, each of FIGS. 3A and 3B illustrates a trailing end of a toner image.

As illustrated in FIG. 3A, in the case where the toner image is not heated by the heating unit 700, image irregularities occur in the toner image. On the other hand, as illustrated in FIG. 3B, in the case where the toner image is heated by the heating unit 700, image irregularities do not occur in the toner image.

Note that, in the present exemplary embodiment, as described above, one of the recording materials P is heated by the heating unit 700 in a state where the recording material P is not sandwiched between a member and the heating unit 700. In other words, the recording material P is heated by the heating unit 700 in a state where pressure is not applied to the recording material P.

Here, if pressure is applied to the recording material P in the heating unit 700, there is a possibility that, in the heating unit 700, air and steam may be jetted out as in the case where air and steam are jetted out at a position immediately after the nip part N. In the heating unit 700 according to the present exemplary embodiment, the occurrence of jetted-out air and steam is suppressed by applying heat to one of the recording materials P in a state where pressure is not applied to the recording material P.

Note that, in the case where the recording materials P are normal sheets, air and steam are less likely to be jetted out at the position immediately after the nip part N. In a case where one of the recording materials P is a normal sheet, since a normal sheet has high air permeability, air and steam in the toner of a toner image may escape to the side on which the recording material P is present in the nip part N. In this case, air and steam are less likely to be jetted out at the position immediately after the nip part N.

In the present exemplary embodiment, as described above, one of the recording materials P is heated from the side on which a surface of the recording material P is present, the surface of the recording material P being opposite to a surface of the recording material P on which toner images have been formed.

Here, in the case where the recording material P is heated from the side on which the surface of the recording material P on which toner images have been formed is present, each of the toner images is likely to melt from the surface side of the toner image, and it becomes difficult for air and steam in the toners of the toner images to escape to the outside unless heat is applied to the recording material P in a non-contact manner.

In the present exemplary embodiment, as described above, the transport belt 810 extends to the nip part N, and one of the recording materials P reaches the nip part N in a state where deformation of the recording material P is suppressed by the transport belt 810.

Here, for example, in the case where a terminating end of the transport belt 810 is positioned in front of the nip part N and where a gap is generated between the transport belt 810 and the nip part N, elongation and contraction of the recording material P are likely to occur in the gap. As in the present exemplary embodiment, in a configuration in which the transport belt 810 extends to the nip part N, the recording material P reaches the nip part N while being restrained, and elongation and contraction of the recording material P are less likely to occur.

### (Others)

Although a case where an image forming operation and a fixing treatment are performed on one of the recording materials P that are cut one by one has been described above as an example, the above-described exemplary embodiment may be applied to a recording material P that is a continuous sheet and that is not cut into individual sheets.

In addition, the heating unit 700 may uniformly apply heat to the recording materials P regardless of the type of the recording materials P. Alternatively, a recognition unit that recognizes the type of the recording materials P may be provided, and switching the heating unit 700 on and off and adjusting the output of the heating unit 700 may be performed on the basis of the type of the recording materials P that has been recognized.

For example, in the case where one of the recording materials P is a resin sheet or a resin film, the heating unit 700 may apply heat to the recording material P, and in the case where the recording material P is a normal sheet, the heating unit 700 may be switched off, or the output of the heating unit 700 may be decreased compared with the case where the recording material P is a resin sheet or a resin film.

Note that the type of the recording materials P may be recognized on the basis of information input by a user through the user interface unit 30 (see FIG. 1) or information transmitted from an external personal computer (PC) or the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing unit that includes a first heating unit and a pressing unit that forms a fixing region, in which a recording material is sandwiched between the pressing unit and the first heating unit and an image on the recording material is thereby fixed onto the recording material;
a second heating unit that applies heat to a portion of the recording material, the portion not having reached the fixing region; and
a deformation-suppression unit that suppresses deformation of the recording material due to the heat applied to the recording material by the second heating unit.

2. The fixing device according to claim 1,
wherein the deformation-suppression unit suppresses elongation or contraction of the recording material.

3. The fixing device according to claim 1,
wherein the recording material reaches the fixing unit in a state where deformation of the recording material is suppressed by the deformation-suppression unit.

4. The fixing device according to claim 2,
wherein the deformation-suppression unit includes a transport member that transports the recording material toward the fixing unit, and
wherein the deformation-suppression unit is configured in such a manner that the recording material is brought into close contact with the transport member, so that elongation or contraction of the recording material is suppressed.

5. The fixing device according to claim 1,
wherein the second heating unit applies heat to a surface of the recording material, the surface being opposite to a surface of the recording material on which the image has been formed.

6. The fixing device according to claim 1,
wherein the second heating unit applies heat to the recording material in a state where the recording material is not sandwiched by a member.

7. The fixing device according to claim 1,
wherein the second heating unit applies heat to the recording material in a state where pressure is not applied to the recording material.

8. The fixing device according to claim 1, further comprising:
a transport member that transports the recording material toward the fixing unit,
wherein the transport member is disposed between the second heating unit and the recording material, which is heated by the second heating unit, and
wherein the second heating unit applies heat to the recording material via the transport member.

9. An image forming apparatus comprising:
an image forming unit that forms an image on a recording material;
a fixing unit that includes a first heating unit and a pressing unit that forms a fixing region, in which the recording material is sandwiched between the pressing unit and the first heating unit and the image on the recording material is thereby fixed onto the recording material, the fixing unit being configured to apply pressure and heat to the recording material, on which the image has been formed by the image forming unit, in such a manner as to fix the image formed on the recording material onto the recording material; and
a second heating unit that applies heat to a portion of the recording material, the portion not having reached the fixing region; and
a deformation-suppression unit that suppresses deformation of the recording material due to the heat applied to the recording material by the second heating unit.
